(19) United States
(12) Patent Application Publication
(10) Pub. No.: US 2026/0064329 A1
(43) Pub. Date: Mar. 5, 2026

(54) PRINTING CONTROL APPARATUS, METHOD OF CONTROLLING PRINTING CONTROL APPARATUS, AND STORAGE MEDIUM

(71) Applicant: CANON KABUSHIKI KAISHA, Tokyo (JP)

(72) Inventor: SOICHIRO KATAYAMA, Kanagawa (JP)

(21) Appl. No.: 19/289,623

(22) Filed: Aug. 4, 2025

(30) Foreign Application Priority Data
Aug. 29, 2024 (JP) 2024-147347

(51) Int. Cl. G06F 3/12

(52) U.S. Cl. CPC G06F 3/121; G06F 3/1236; G06F 3/1288

(57) ABSTRACT

A printing control apparatus includes: at least one memory and at least one processor which function as: an obtaining unit configured to obtain contract information indicating a contract status about use of a specific service relating to a delivery of a consumable for use in printing; a processing unit configured to perform transmission processing of transmitting status information on the printing control apparatus to a server system after a specific event has occurred; and a display control unit configured to perform control such that, in a case where an error of failing the transmission processing after the occurrence of the specific event has occurred, predetermined information on the error is not displayed on a display unit if there is no contract with the specific service, and the predetermined information is displayed if there is a contract with the specific service, based on the contract status indicated by the contract information.

### BACKGROUND

### Field of the Technology

The present disclosure relates to a printing control apparatus, a method of controlling a printing control apparatus, and a storage medium.

### Description of the Related Art

In printing devices having a network function, services such as consumable delivery services and contract-type flat-rate services which manage operation information of a printing device and consumables such as inks with a management server have been widespread. Japanese Patent Laid-Open No. 2022-170008 discloses a technique of providing information on a contracted service to a user by performing communications between a printing device and a management server.

There is a demand for a technique of flexibly providing a user with information on a failure which has occurred, in accordance with a contract state and a communication state of a printing device.

### SUMMARY

A printing control apparatus according to the present disclosure includes: at least one memory and at least one processor which function as: an obtaining unit configured to obtain contract information indicating a contract status about use of a specific service relating to a delivery of a consumable for use in printing; a processing unit configured to perform transmission processing of transmitting status information on the printing control apparatus to a server system after a specific event has occurred; and a display control unit configured to perform control such that, in a case where an error of failing the transmission processing after the occurrence of the specific event has occurred, predetermined information on the error is not displayed on a display unit in a case where there is no contract with the specific service, and the predetermined information on the error is displayed on the display unit in a case where there is a contract with the specific service, based on the contract status indicated by the contract information.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an entire system;

FIG. 2 is a block diagram showing a schematic configuration of hardware of a printer;

FIG. 3 is a block diagram showing a schematic configuration of a server;

FIG. 4A is a flowchart of processing which is performed at the time of occurrence of an error;

FIG. 4B is a flowchart of processing which is performed at the time of occurrence of an error;

FIG. 5A is a diagram showing an example of an error screen;

FIG. 5B is a diagram showing an example of an error screen;

FIG. 5C is a diagram showing an example of an error screen;

FIG. 6 is a diagram showing examples of classified errors;

FIG. 7 is a diagram showing a screen of an error history (list of errors);

FIG. 8A is a flowchart of processing for storing an error which has occurred and displaying a list of errors;

FIG. 8B is a flowchart of processing for storing an error which has occurred and displaying a list of errors;

FIG. 9A is a diagram showing a screen of an error history (list of errors) displayed on a control device; and

FIG. 9B is a diagram showing a screen which is displayed in a case where an error has been selected from the error history (list of errors) displayed on the control device.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with “S”.

### First Embodiment

In a case where a user has already contracted with a consumable delivery service, there is a case where information necessary for the consumable delivery does not arrive at a management server depending on a network environment of the user, the state of a printing device, and the state of the management server. It is necessary to present information for resolving the failure to the user who has contracted with the consumable delivery service. On the other hand, since it is unnecessary to present unnecessary information on a failure to the user who has not contracted with the consumable delivery service, flexible information provision has been demanded.

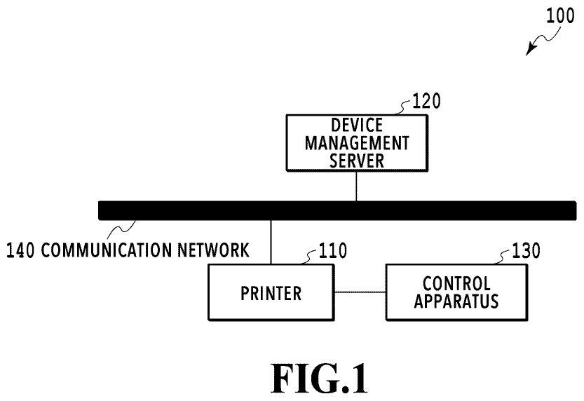

FIG. 1 is a configuration diagram showing a configuration of an entire processing system of the present embodiment. A processing system 100 includes a printer 110 as a printing device, a device management server 120, and a control device 130. The printer 110 and the device management server 120 are connected via a communication network 140 such as the Internet. The printer 110 and the control device 130 (a terminal device such as a smartphone, a tablet terminal, or a personal computer (PC)) are connected by a wireless LAN or the like via a USB cable or an access point. In addition, the target of the present disclosure is a printing control apparatus including the printer 110 and the control device 130. That is, the printer 110 and the control device 130 cooperate to allow the printing control apparatus to function, and the printing control apparatus executes the processing of the present disclosure. Moreover, although in the present embodiment, the printer 110 and the control device 130 are described as being separate bodies, the present embodiment is not limited to this. The printer 110 and the control device 130 may be integrated with each other. Although in the present embodiment, the printer 110 is assumed to be an MFP (Multi Function Peripheral), the present embodiment is not limited to this. The printer 110 may be an SFP (Single Function Peripheral).

The printer 110 stores contract information in a NVM (Non Volatile Memory) 104 of the printer 110, which will be described later, and the control device 130 controls the printer 110 in accordance with the stored contract information. Here, the contract information is information indicating the contract status about use of a specific service such as a consumable delivery service. The printer 110 receives the contract information by communicating with the device management server 120 via the communication network 140. It is assumed that the communication between the printer 110 and the device management server 120 uses a communication protocol such as a HyperText Transfer Protocol (hereinafter, referred to as “HTTP”), and for the control method, a known method is used. In the control device 130, dedicated application and Internet browser have been installed, and the dedicated application and Internet browser are used for connection with the printer 110 and control thereof. In addition, although the printer 110 and the control device 130 are directly connected, the present embodiment is not limited to this. For example, the present embodiment may have a configuration in which the printer 110 and the control device 130 transmit and receive contract information to and from each other via the communication network 140. Note that the contract information and the control of the printer 110 which is performed in accordance with the contract information will be described later in detail.

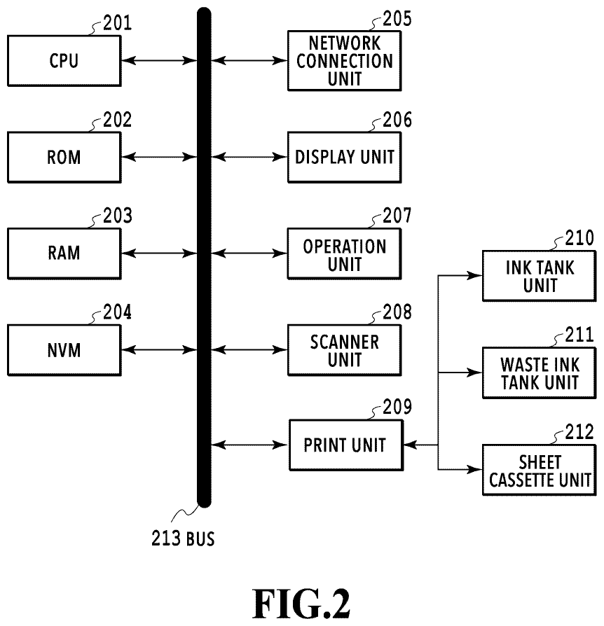

FIG. 2 is a block diagram showing a schematic configuration of hardware of the printer 110. The printer 110 includes a CPU 201, a ROM 202, a RAM 203, a NVM 204, a network connection unit 205, a display unit 206, and an operation unit 207. The CPU 201 is a central processing unit for controlling each unit in the printer 110. The ROM 202 stores various program codes. The RAM 203 temporarily stores data such as image data at the time of executing each service, and buffering or the like is performed thereon. In addition, the RAM 203 also stores image data and the like received by the network connection unit 205, which will be described later. The NVM 204 is a non-volatile memory, and stores non-volatile information. For example, the NVM 204 stores individual identification information of the printer 110, delivery destination information, the setting of a language to be displayed in the display unit 206, and the like. In the printer 110 of the present embodiment, contract information for each service, which will be described later, is also stored in the NVM 204.

The network connection unit 205 is connected to an external device via a USB (Universal Serial Bus) or a network, and communicates with the external device. That is, the network connection unit 205 also functions as a data transmission unit and a data reception unit for the printer 110. In the present embodiment, the printer 110 communicates with the device management server 120 via the communication network 140 by using the network connection unit 205, and communicates directly with the control device 130.

The display unit 206 is configured with, for example, a liquid-crystal display device or the like, and is capable of displaying a character, a figure, an indicator, and the like. Information to be displayed by the display unit 206 includes, for example, the display of information on the failure which has occurred in the printer 110. Note that the display in the display unit 206 is controlled by a display control component, which is one of functions which the CPU 201 has. The operation unit 207 has switches and hard keys for the user to perform various input operations. In addition, it is also possible to employ a mode in which the display unit 206 also functions as an operation unit for performing input operation and the like, like a touch panel.

In addition, the printer 110 includes a scanner unit 208, a print unit 209, an ink tank unit 210, a waste ink tank unit 211, and a sheet cassette unit 212. The scanner unit 208 optically reads an original document set on a platen glass, converts the original document to electronic data, transmits image data further converted into a designated file format to an external device via the communication network 140, and stores the image data in a storage device such as a hard disk, which is not shown. The storage device is not limited to a hard disk, but may be an SSD (Solid State Drive), a flash memory, or cloud storage. In addition, the printer 110 also has a copy function. The printer 110 transfers image data generated by reading an original document placed on the platen glass with the scanner unit 208 to the print unit 209, and the print unit 209 prints an image on a printing medium based on the image data. In the printer 110, the scanner function is achieved by the scanner unit 208, and the print function (printing function) is achieved by the print unit 209.

The print unit 209 is supplied with an ink from the ink tank unit 210, and performs a printing process on a printing medium such as a printing sheet. In addition, the print unit 209 prints an image on the printing medium by an inkjet system based on image data received from the outside, image data read by the scanner unit 208, or the like. Note that the printing system of the print unit 209 is not limited to the inkjet system, but may be another printing system such as an electrophotographic system or a thermal transfer system, for example.

The ink tank unit 210 includes an ink injection port, into which the ink is injected from an ink bottle, to store the ink. Note that as another configuration of the ink tank unit 210, the ink tank unit 210 may have a configuration in which an ink cartridge filled with the ink is mounted, and the ink in this ink cartridge is supplied to the print unit 209 to execute print. For example, a mode in which the printer 110 includes a carriage which allows the print unit 209 to scan relative to the printing medium, and the carriage in which an ink cartridge is mounted forms the ink tank unit 210 in the present embodiment can be considered.

The waste ink tank unit 211 receives a waste ink which is generated in a case of performing the printing process with the print unit 209 by using the ink supplied from the ink tank unit 210. The waste ink indicates an ink which is used for a purpose other than the ejection onto the printing medium, such as ink suction which is performed before ink ejection onto the printing medium in order to stabilize the ink ejection. Status information which indicates the remaining volume of the waste ink tank unit 211 indicates a receivable remaining volume calculated based on the amount of the waste ink discharged from the print unit 209 outside the range of the printing medium and the volume of the waste ink tank unit 211. In this case, the result of calculation of the remaining volume is corrected by mounting a sensor for detecting the amount of the waste ink mounted in the waste ink tank unit 211. Alternatively, a configuration in which a remaining volume receivable in the waste ink tank unit 211 is calculated by using only a sensor may be employed.

The sheet cassette unit 212 stores a printing medium such as sheets to be supplied to the print unit 209. The print unit 209 performs printing on the supplied printing medium to form an image on the printing medium. Sheet information of the number of remaining sheets in the sheet cassette unit 212 and the like indicates the number of remaining sheets calculated based on the number of sheets supplied to the print unit 209 and the number of sheets stored in the sheet cassette unit 212. Note that the result of calculation of the number of remaining sheets may be corrected by mounting a sensor for detecting the number of sheets stored in the sheet cassette unit 212. Alternatively, the number of remaining sheets may be obtained by using the result of detection of the sensor. The units of the printer 110 are connected with one another via a bus 213, and are capable of transmitting and receiving various data to and from one another.

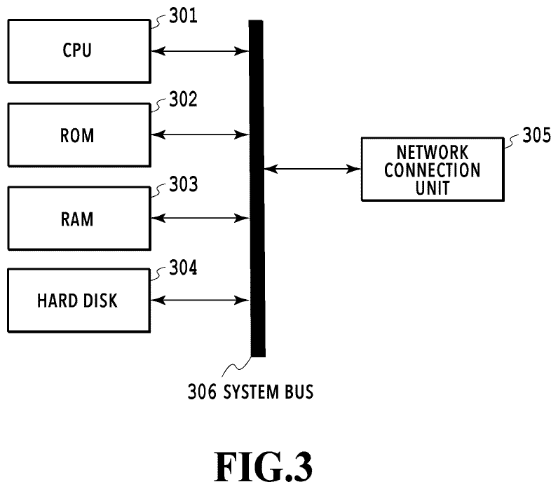

FIG. 3 is a block diagram showing a schematic configuration of hardware of the device management server 120. The device management server 120 includes a CPU 301, a ROM 302, a RAM 303, a hard disk 304, and a network connection unit 305. The CPU 301 performs processing such as calculation, determination, and control of data or instructions in accordance with software stored in the ROM 302, the RAM 303, or the hard disk 304. The RAM 303 is used as a temporary storage area for the CPU 301 to perform various processing. The hard disk 304 stores an operating system (OS), application software, programs, and the like. In addition, device information on each printer, which will be described later, and a record table of the contract status of each service are also stored in the hard disk 304. The hard disk 304 may be another storage device such as an SSD or a flash memory.

A system bus 306 performs communication of data between the CPU 301 and storage devices such as the ROM 302, the RAM 303, and the hard disk 304. The network connection unit 305 communicates data with an external device via the same network and the Internet in accordance with a protocol such as TCP/IP by using a wireless LAN or a wired LAN supporting a specification such as IEEE 802.11ax or IEEE 802.11be. Note that the configuration of the present embodiment is not limited to the configuration shown in FIG. 3. The present embodiment may have a configuration in which a service which can be provided by the device management server 120 is achieved by using a server on a cloud. In addition, the device management server 120 does not necessarily have to be configured with a single server. That is, the function may be achieved by a server system composed of a plurality of servers, or a single server configured by integrating a plurality of servers. For example, the hard disk 304 may be cloud storage.

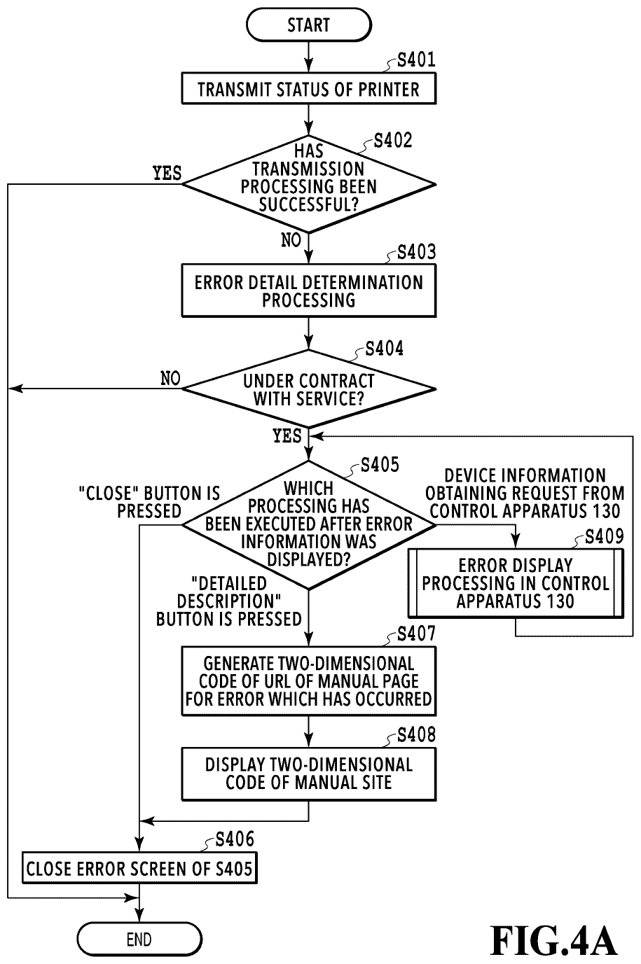

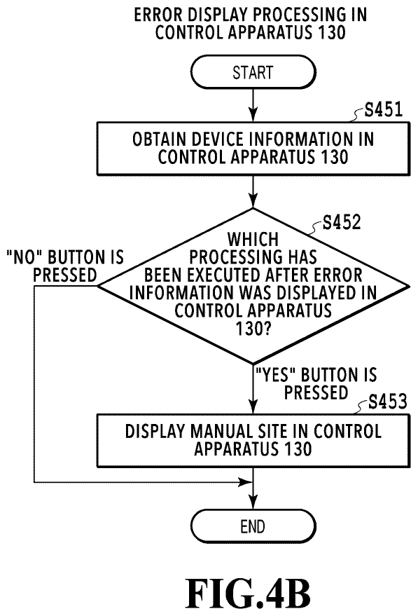

Next, an error display corresponding to a contract state of the printer 110 for a consumable delivery service in the present embodiment will be described by using a flowchart of FIG. 4A. Note that the processing of the flowchart of FIG. 4A is executed by the CPU 201 reading programs onto the RAM 203. In addition, the processing of the flowchart of FIG. 4A is started by the CPU 201 transmitting the status of the printer 110 to the device management server 120 after some operation has been performed such as an operation in which the power supply of the printer 110 has been turned on or an operation in which printing has been executed.

In S401, after some operation has been performed such as an operation in which the power supply of the printer 110 has been turned on or an operation in which printing has been executed, the CPU 201 transmits the status of the printer 110 to the device management server 120. Here, the status includes one or a plurality of pieces of information among the remaining amount of a consumable, the number of print sheets, and the occurrence state of a printing error. In S402, the CPU 201 determines whether the transmission processing has been successful. The determination on whether the transmission processing has been successful is made by a response from the device management server 120 or a response from the network connection unit 205. In a case where the printer 110 has received a response such as ACK from the device management server 120, it is determined that the transmission processing has been successful. In a case where the printer 110 has received a response such as NAK from the device management server 120, it is determined that the transmission processing has not been successful. In this case, there is a case where the response of NAK includes information on a cause for which the transmission processing has not been successful (a cause of an error which has occurred). Alternatively, there is a case where information on a cause for which the transmission processing has not been successful (a cause of an error which has occurred) is transmitted from the device management server 120 to the printer 110, following the response of NAK. In a case where the transmission processing has been successful, the processing of the present flowchart ends. In a case where the transmission processing has not been successful, the processing proceeds to S403.

In S403, the CPU 201 performs processing of determining a cause for which the transmission processing (communication) has not been successful, based on a reception of the cause of the error which has occurred from the network connection unit 205, the cause of the error included in the NAK response, or the cause of the error transmitted following the NAK response. The CPU 201 classifies the error which has occurred, and support numbers (error codes) are allocated to the classified errors, respectively. After the above-mentioned processing on the error ends, the processing proceeds to S404. That is, information on an error varies in accordance with the error which has occurred. In S404, the CPU 201 determines whether the printer 110 has contracted with the consumable delivery service. In a case where the printer 110 has contracted with the consumable delivery service, the processing proceeds to S405. In a case where the printer 110 has not contracted with the consumable delivery service, the processing of the flowchart shown in FIG. 4A ends without displaying information on the error which has occurred. In this way, since information on the failure which is unnecessary for the user who has not contracted with the consumable delivery service is not presented, the usability is improved.

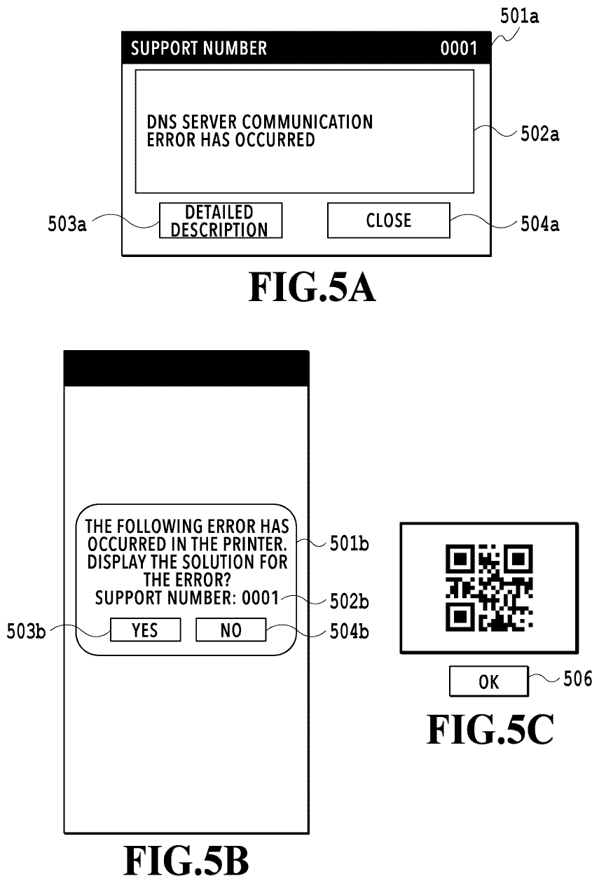

In S405, the CPU 201 displays information on the error classified in S403 on the display unit 206 of the printer 110. An example of the error screen displayed on the display unit 206 of the printer 110 is shown in FIG. 5A. In the error screen of FIG. 5A, in a case where a “CLOSE” button 504a is pressed, the processing proceeds to S406. In the error screen of the FIG. 5A, in a case where a “DETAILED DESCRIPTION” button 503a is pressed, the processing proceeds to S407. In a case where the control device 130 transmits a device information obtaining request to the printer 110 during the display of the error screen of FIG. 5A, the CPU 201 of the printer 110 transmits device information to the control device 130. Then, the processing proceeds to an “ERROR DISPLAY PROCESSING IN CONTROL APPARATUS 130” in S409 shown in the flowchart of FIG. 4B. The device information includes error information. The error information is information indicating an error type, and the error information also includes a support number allocated to each error type, and the like. Although the period in which the control device 130 can obtain the device information including the error information is a branch in S405 in FIG. 4A, the configuration is not limited to this. The period in which the control device 130 can obtain the device information may be a period from S405 to the completion of the processing of S406. Note that in S405, the condition for displaying an error on the display unit 206 may be set to a condition that the printer 110 is not executing another processing, or that the user is not operating the operation unit 207. That is, it is possible to employ a configuration in which an error is not displayed in a case where the printer 110 is executing another specific processing, or in a case where the user is operating the operation unit 207.

In S406, the CPU 201 closes the error screen of FIG. 5A, and ends the processing of the flowchart shown in FIG. 4A. In S407, the CPU 201 generates a two-dimensional code shown in FIG. 5C, such as a QR code (registered trademark), including a Uniform Resource Locator (URL) of a manual page for the error which has occurred, and the processing proceeds to S408. In S408, the CPU 201 displays the generated two-dimensional code on the display unit 206 of the printer 110. Once the two-dimensional code is read by using a smartphone or the like, a web manual page describing a solution for the corresponding error is displayed on the smartphone or the like. This allows the user to refer to the displayed web manual page. In a case where an “OK” button 506 in FIG. 5C is pressed, the processing proceeds to S406.

The two-dimensional code is generated from an URL obtained by combining a predetermined URL (fixed value), printer information, and error information generated from error information. More specifically, a two-dimensional code including URL information obtained by adding, as URL parameters, at least printer information (information specifying the model of the printer) and error information (information indicating the error type) to a predetermined URL (URL for accessing the manual) is generated. The user reads this two-dimensional code by using a camera of a smartphone, or the like. In this way, a portion showing a solution for the type of the error, which has occurred, in the manual for the model of the printer in which the error has occurred can be displayed on the device which has read the two-dimensional code such as the smartphone. The user can perform an appropriate handling corresponding to the model of the printer and the error type in accordance with the displayed manual.

FIG. 4B is a flowchart showing specific processing of “ERROR DISPLAY PROCESSING IN CONTROL APPARATUS 130”. In S451, the CPU 301 of the control device 130 such as a smartphone or a personal computer (PC) receives device information including error information of the error which has occurred from the printer 110, and the processing proceeds to S452. In S452, an error screen shown in FIG. 5B is displayed with a pop-up window on an application activated in the control device 130. On the error screen of FIG. 5B, error information such as a support number which is allocated to each error type is displayed. Here, in a case where a “YES” button 503b is pressed, the processing proceeds to S453. In a case where a “NO” button 504b is pressed, the pop-up window of the error is closed. In S453, the CPU 301 of the control device 130 activates a web browser and displays a web manual which describes an error solution procedure on the display device. Note that in the present embodiment, there can be a case where the processing from S405 to S408 and the processing from S451 to S453 are executed in parallel.

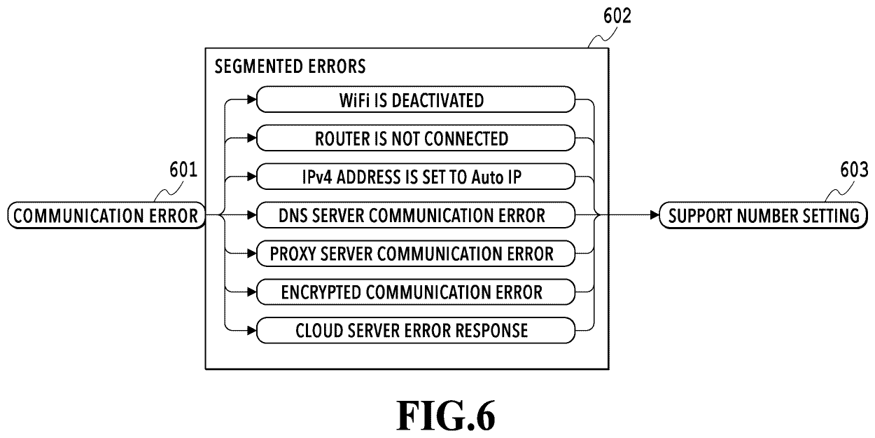

FIG. 6 is a diagram showing examples of errors in which communication errors which have occurred in communication between the printer 110 and the device management server 120 are segmented. As information indicating the type of an error, for example, there is type information as described below. First error-type information is type information indicating that the wireless LAN is deactivated. Second error-type information is type information indicating that a router is not connected. Third error-type information is type information indicating that the setting of IPv4 is Auto IP (Automatic Private IP Addressing). Fourth error-type information is type information indicating that an error has occurred in communication with a DNS server. Fifth error-type information is type information indicating that an error has occurred in communication with a proxy server. Sixth error-type information is type information indicating that an error has occurred in encrypted communications. Seventh error-type information is type information indicating that a response from a server system was an error. In the printer 110, a support number is allocated to each of the above-mentioned error types. That is, an error type and a support number are in one-to-one correspondence. The error types in the printer 110, which are shown in FIG. 6, are examples, and other communication errors are also included depending on the hardware and software configuration of the device.

As described above, the present embodiment makes it possible to flexibly provide the user with information on the failure which has occurred, in accordance with the contract state and the communication state of the printing device. That is, since information on the failure which is unnecessary for the user who has not contracted with the consumable delivery service is not presented, the usability is improved. Moreover, information on an error which has occurred, and the like can be provided to the user who has contracted with the consumable delivery service.

### Second Embodiment

In the first embodiment, the example in which detailed information on an error which has occurred is displayed was described. There is a case where the user wants to check whether an error which occurred in the past has occurred in addition to an error which is currently occurring. In such a case, the user desires to browse detailed information on errors which occurred in the past. In the present embodiment, an example of obtaining error detailed information from an error history will be described.

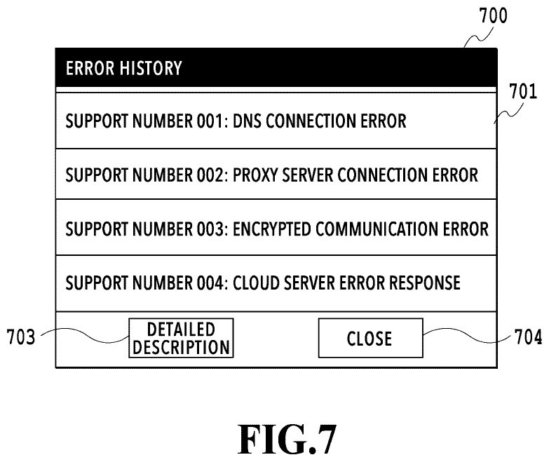

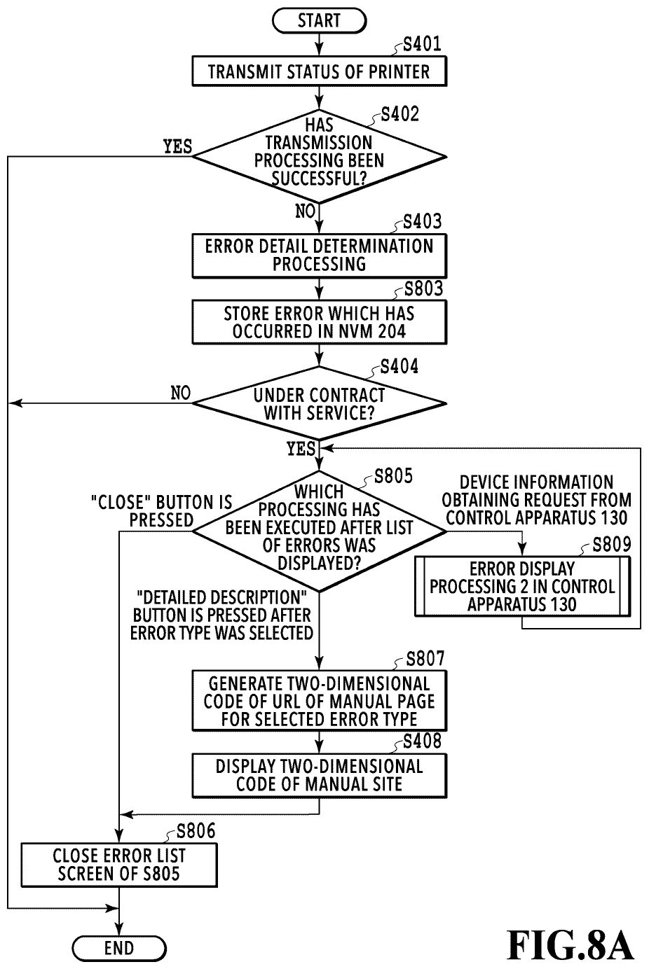

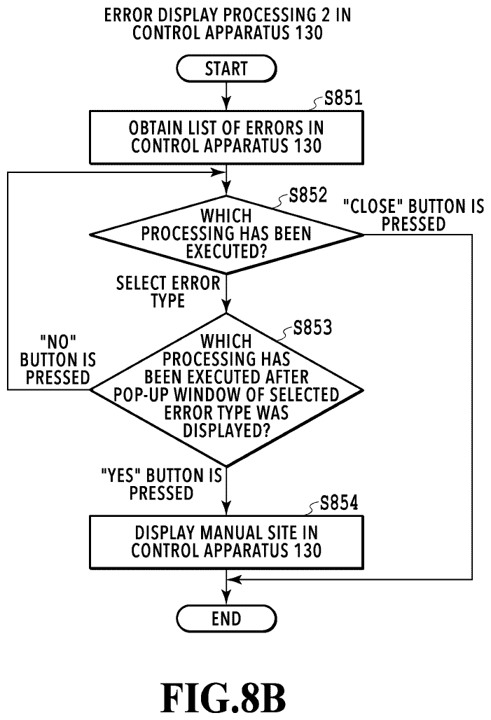

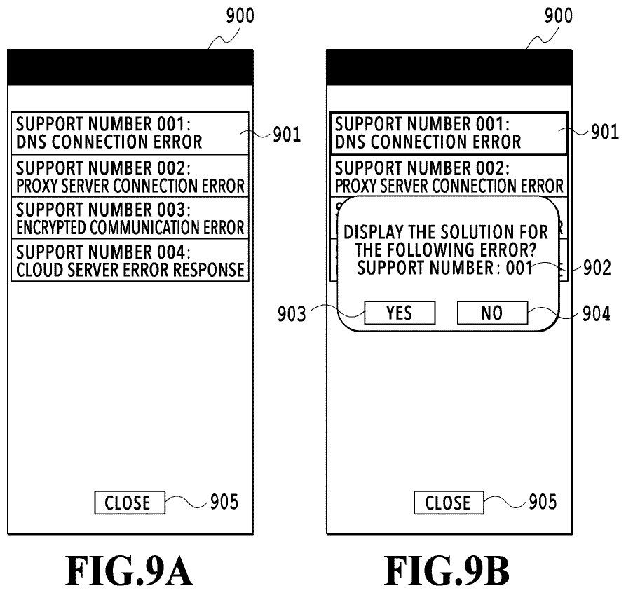

FIG. 7 is a diagram showing an example of a screen of an error history which is displayed on the display unit 206 of the printer 110 in the present embodiment. That is, FIG. 7 is a screen showing a list of errors which occurred in the past. Error types (support numbers) determined in S403 of FIG. 8A, which will be described later, are stored in the NVM 204 of the printer 110. That is, the list of errors which occurred in the past is also included in the above-mentioned error information. In a case where the printer 110 has contracted with the consumable delivery service, the list of errors of FIG. 7, which occurred in the past, can be displayed by the user operation from a menu screen of the display unit 206 of the printer 110. In addition, by selecting an individual error from the list of errors of FIG. 7, a web manual page relating to the selected error can be displayed. Moreover, information of the list of errors stored in the NVM 204 can also be transferred to the control device 130 via an application installed in the control device 130. It is also possible to refer to the list of errors in the control device 130 and check the detail of error information from FIG. 9A, which will be described later.

FIG. 8A is a flowchart in which processing of storing errors and displaying the stored list of errors is added to the flowchart shown in FIG. 4A. Note that the processing of the flowchart of FIG. 8A is executed by the CPU 201 reading programs onto the RAM 203. In addition, the processing of the flowchart of FIG. 8A is started by the CPU 201 transmitting the status of the printer 110 to the device management server 120 after some operation has been performed such as an operation in which the power supply of the printer 110 has been turned on or an operation in which printing has been executed. The processing of steps which have already been described in FIG. 4A and FIG. 4B will not be described.

In S403, error detail determination processing is executed, and then, the processing proceeds to S803. In S803, the CPU 201 stores an error, which has occurred, in the NVM 204 of the printer 110, and the processing proceeds to S404. In S404, in a case where the user has been contracting with the consumable delivery service, the processing proceeds to S805. In S404, in a case where the user has not been contracting with the consumable delivery service, the processing of the flowchart shown in FIG. 8A ends without displaying a list of errors.

In S805, in a case where the display of the list of errors stored in NVM 204 is selected from a menu of the display unit 206, the CPU 201 displays the screen of the list of errors of FIG. 7 on the display unit 206. In a case where a “Close” button 704 is pressed in the screen of the list of errors of FIG. 7, the processing proceeds to S806. In the screen of the list of errors of FIG. 7, in a case where the error type (support number) desired to display is selected, and then a “DETAILED DESCRIPTION” button 703 is pressed, the processing proceeds to S807. During the display of the screen of the list of errors of FIG. 7, in a case where the control device 130 transmits a device information obtaining request to the printer 110, the CPU 201 of the printer 110 transmits device information to the control device 130. Then, the processing proceeds to “ERROR DISPLAY PROCESSING 2 IN CONTROL APPARATUS 130” of S809 shown in the flowchart of FIG. 8B. The device information includes the above-mentioned error information, and the error information also includes the list of errors. Although in the flowchart of FIG. 8A, the period in which the control device 130 can obtain the list of errors is a branch in S805, the configuration is not limited to this. In a case where the user has contracted with the consumable delivery service, the timing of obtaining the list of errors is not limited in a case where the printer 110 and the control device 130 can be connected to each other.

In S806, the CPU 201 closes the screen of the list of errors of FIG. 7, and the processing of the flowchart shown in FIG. 8A ends. In a case where the processing proceeds from S805 to S807, in S807, the CPU 201 generates a two-dimensional code including an URL of a manual page of the selected error type (support number), and executes processing of S408 and S806.

FIG. 8B is a flowchart showing specific processing of “ERROR DISPLAY PROCESSING 2 IN CONTROL APPARATUS 130”. In S851, the CPU 301 of the control device 130 obtains device information including the list of errors from the printer 110, and displays the obtained list of errors on the display device of the control device 130 (see FIG. 9A). After the screen of the list of errors shown in FIG. 9A is displayed on the display device of the control device 130, processing proceeds to S852.

In S852, the CPU 301 of the control device 130 determines the executed processing. In S852, in a case where a “CLOSE” button 905 of FIG. 9A is pressed, the CPU 301 of the control device 130 closes the screen of the list of errors shown in FIG. 9A, and the processing of the flowchart shown in FIG. 8B ends. In S852, in a case where an error type (support number) is selected by a user operation, the processing proceeds to S853. FIG. 9B shows an example in which “DNS CONNECTION ERROR” shown in a region 901 has been selected.

In S853, as shown in FIG. 9B, the CPU 301 of the control device 130 displays a pop-up window 902 on the screen of the obtained list of errors. In the pop-up window 902 of FIG. 9B, in a case where a “YES” button 903 is pressed, the processing proceeds to S854. In the pop-up window 902 of FIG. 9B, in a case where a “NO” button 904 is pressed, the CPU 301 of the control device 130 closes the pop-up window 902 of FIG. 9B, and the processing returns to S852. In S854, the CPU 301 of the control device 130 activates the web browser, and displays a web manual in which an error solution procedure is described on the display device. Note that in the present embodiment, there is also a case where the processing from S805 to S408 and the processing from S851 to S854 are executed in parallel.

In this way, it becomes possible to flexibly provide the user with information on the failure which has occurred, in accordance with the contract state and the communication state of the printing device. In addition, it becomes possible to obtain detailed information of an error which has occurred and detailed information of another error, such as an error which occurred in the past, so that the usability is improved.

Note that although the processing has been described such that the processing of the flowchart of FIG. 4A and FIG. 8A is performed by the CPU 201 of the printer 110, and the processing of the flowchart of FIG. 4B and FIG. 8B is performed by the CPU 301 of the control device 130, the configuration is not limited to this. The above-mentioned various controls may be performed by a single piece of hardware, or the processing may be divided by a plurality of pieces of hardware (for example, a plurality of processors and circuits) to control the entire system.

In addition, although the present disclosure has been described in detail based on the embodiments, the present disclosure is not limited to these specific embodiments, and various modes in a range without departing from the gist of the present disclosure are also included in the present disclosure. Moreover, each above-mentioned embodiment merely shows one embodiment of the present disclosure, and the embodiments can be combined as appropriate.

In addition, although the above-mentioned embodiments have been described by giving an example in which the present disclosure is applied to a printing control apparatus, the present disclosure is not limited to this example. The present disclosure can be applied to a scanner control apparatus which reads an image, a FAX control apparatus which performs FAX communication, a multi function peripheral having a plurality of functions such as a copy function and a printing function, a display control apparatus which can display a plurality of images, and a display control apparatus which is capable of touch input.

It becomes possible to flexibly provide the user with information on the failure which has occurred, in accordance with the contract state and the communication state of the printing device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-147347, filed Aug. 29, 2024, which is hereby incorporated by reference herein in its entirety.

What is claimed is:

1. A printing control apparatus comprising at least one memory and at least one processor which function as:
an obtaining unit configured to obtain contract information indicating a contract status about use of a specific service relating to a delivery of a consumable for use in printing;
a processing unit configured to perform transmission processing of transmitting status information on the printing control apparatus to a server system after a specific event has occurred; and
a display control unit configured to perform control such that, in a case where an error of failing the transmission processing after the occurrence of the specific event has occurred, predetermined information on the error is not displayed on a display unit in a case where there is no contract with the specific service, and the predetermined information on the error is displayed on the display unit in a case where there is a contract with the specific service, based on the contract status indicated by the contract information.

2. The printing control apparatus according to claim 1, wherein the specific event is an event that a power supply of the printing control apparatus has been turned on, or an event that printing by the printing control apparatus has been executed.

3. The printing control apparatus according to claim 1, wherein the obtaining unit obtains the contract information from a server system which provides the specific service.

4. The printing control apparatus according to claim 1, wherein the predetermined information varies depending on a type of the error.

5. The printing control apparatus according to claim 1, wherein the predetermined information includes information indicating a type of the error.

6. The printing control apparatus according to claim 5, wherein the display control unit further performs control for displaying a solution for the error in accordance with the type of the error.

7. The printing control apparatus according to claim 6, wherein the control for displaying a solution for the error in accordance with the type of the error is control for displaying, from a manual, a part explaining the solution for the error corresponding to the type of the error.

8. The printing control apparatus according to claim 6, wherein the control for displaying a solution for the error in accordance with the type of the error is to display information including Uniform Resource Locator (URL) information obtained by adding the type of the error, as a URL parameter, to a URL for accessing a manual.

9. The printing control apparatus according to claim 8, wherein the URL information further includes information specifying a model of a printing device.

10. The printing control apparatus according to claim 9, wherein the display control unit displays a two-dimensional code including the URL information on the display unit.

11. The printing control apparatus according to claim 5, wherein the information indicating the type of the error is information indicating of which type the error is among a plurality of types including a first type corresponding to a wireless LAN being deactivated; a second type corresponding to a router not being connected; a third type corresponding to a setting of IPv4 being Auto IP (Automatic Private IP Addressing); a fourth type corresponding to an error having occurred in communication with a DNS server; a fifth type corresponding to an error having occurred in communication with a proxy server; a sixth type corresponding to an error having occurred in encrypted communication; and a seventh type corresponding to a response from the server system being an error.

12. The printing control apparatus according to claim 1, wherein the status information is information indicating at least one of a remaining amount of the consumable, the number of print sheets, and an occurrence state of a printing error.

13. The printing control apparatus according to claim 1, wherein
the predetermined information on the error further includes a list of the error which occurred in the past, and
the display control unit displays the list of the error which occurred in the past on the display unit in a case where there is a contract with the specific service.

14. A method of controlling a printing control apparatus, comprising:
obtaining contract information indicating a contract status about use of a specific service relating to a delivery of a consumable for use in printing;
performing transmission processing of transmitting status information on the printing control apparatus to a server system after a specific event has occurred; and
performing control such that, in a case where an error of failing the transmission processing after the occurrence of the specific event has occurred, predetermined information on the error is not displayed on a display unit in a case where there is no contract with the specific service, and the predetermined information on the error is displayed on the display unit in a case where there is a contract with the specific service, based on the contract status indicated by the contract information.

15. A non-transitory computer readable storage medium storing a program which causes a computer to execute a method of controlling a printing control apparatus, the method comprising:
obtaining contract information indicating a contract status about use of a specific service relating to a delivery of a consumable for use in printing;
performing transmission processing of transmitting status information on the printing control apparatus to a server system after a specific event has occurred; and
performing control such that, in a case where an error of failing the transmission processing after the occurrence of the specific event has occurred, predetermined information on the error is not displayed on a display unit in a case where there is no contract with the specific service, and the predetermined information on the error is displayed on the display unit in a case where there is a contract with the specific service, based on the contract status indicated by the contract information.
